(19) United States
(12) Patent Application Publication
(10) Pub. No.: US 2015/0093635 A1
(43) Pub. Date: Apr. 2, 2015

(54) ADDITIVE FOR AN ELECTROLYTE OF A LITHIUM-BASED SECONDARY BATTERY CELL

(71) Applicants: Jens GRIMMINGER, Leonberg (DE); Marcus WEGNER, Leonberg (DE)

(72) Inventors: Jens GRIMMINGER, Leonberg (DE); Marcus WEGNER, Leonberg (DE)

(73) Assignee: Robert Bosch GmbH, Stuttgart (DE)

(21) Appl. No.: 14/502,462

(22) Filed: Sep. 30, 2014

(30) Foreign Application Priority Data
Oct. 1, 2013 (DE) 10 2013 219 865.5

(51) Int. Cl. H01M 10/0567; H01M 10/0525

(52) U.S. Cl. CPC H01M 10/0567; H01M 10/0525; H01M 2300/0025; H01M 2220/20
USPC 429/188

(57) ABSTRACT

An additive is described for an electrolyte of a lithium-based secondary battery cell, including at least one additive unit, which includes a closed capsule, which is filled at least partially with at least one additive dissolved in a fluid or with at least one liquid additive, characterized in that the capsule is designed in coordination with the additive, in such a way that the additive may reach the environment around the capsule by diffusion out of the capsule.

### FIELD OF THE INVENTION

Lithium ion secondary battery cells are very promising candidates for use in electric vehicles because of their high specific energy density. Even higher energy densities are achieved, for example, by lithium-metal secondary battery cells, for example, lithium-sulfur and lithium-air secondary battery cells.

### BACKGROUND INFORMATION

High demands are made of all types of secondary battery cells with respect to their cycle stability and safety. A wide variety of additives, for example, SEI-forming agents (SEI=solid electrolyte interface) or overload protection substances are therefore added to the electrolyte of secondary battery cells in lithium-ion secondary battery cells. Additives such as LiNO₃ are also added to the electrolyte in lithium-metal secondary battery cells, for example, lithium-sulfur secondary battery cells.

According to the present related art, additives are added to the electrolyte in a certain quantity during the manufacture of a secondary battery cell. However, these additives may have a negative effect on the properties of the electrolyte. Furthermore, additives may be consumed by side reactions after a short period of time and are therefore no longer available at a later point in time.

### SUMMARY

The subject matter of the present invention is an additive for an electrolyte of a lithium-based secondary battery cell including at least one additive unit which includes a closed capsule, which is filled at least partially with at least one additive dissolved in a fluid or with at least one liquid additive, characterized in that the capsule is designed in coordination with the additive in such a way that the additive may reach the environment around the capsule by diffusion out of the capsule.

The electrolyte typically includes one or more electrolyte solvents, selected from the group of carbonates, for example, such as ethylene carbonate (EC), and ethers, for example, ethylene glycol dimethyl ether (DME), and one or more conducting salts, for example, lithium hexafluorophosphate (LiPF6) or lithium bis(trifluoromethanesulfonyl)imide (LiTFSI). In addition, additive substances such as vinylene carbonate (VC), for example, may also be included. In addition, a gelatinous electrolyte or gel polymer electrolyte may also be present. It includes at least one polymer, which is impregnated with at least one or more electrolyte solvents and contains at least one conducting salt and possibly additive substances. The materials described above are to be understood as not restrictive.

Continuous release of the additive into the electrolyte may take place through the diffusion of the additive according to the present invention out of the capsule, thus permitting in particular a uniform desired concentration of the additive in the electrolyte over the entire lifetime of a secondary battery cell having such a design. Release of the additive into the electrolyte may be adjusted in such a way that the concentration of the additive in the electrolyte is high enough to reliably ensure the function of the additive and to replace any additive which has already been consumed. At the same time, release of the additive into the electrolyte may be selected to be adequately low in order to prevent possible unwanted effects of the additive on the operation of a secondary battery cell having a corresponding design.

The diffusion rate may be adjusted through the type of material used to form the capsule, for example, a polymer, through the pore size of the capsule, through the thickness of the capsule wall, through the glass transition temperature of the polymer used to form the capsule or the like. Virtually no diffusion takes place below the glass transition temperature of a corresponding polymer which is used, but much higher diffusion rates may be achieved above the glass transition temperature of the polymer.

The dimensioning of the capsule may be in the nanometer range or in the micrometer range.

In addition, the subject matter of the present invention is an additive for an electrolyte of a lithium-based secondary battery cell including at least one additive unit, which includes a closed capsule filled at least partially with at least one additive in the form of a solid, characterized in that the additive liquefies above a predefinable temperature limiting value, the capsule being designed in coordination with the additive in such a way that the liquefied additive may reach the environment around the capsule by diffusion out of the capsule.

With this additive, diffusion may take place through the capsule as soon as at least some of the additive in the form of a solid contained in the capsule has liquefied. Below the temperature limiting value, no additive is released by the additive unit.

Two or more different additives may also be present as a mixture in a capsule.

The additive may be, for example, an organic carbonate, for example, vinylene carbonate, a nitrile, a halogen compound, for example, fluoroethylene carbonate, an aromatic hydroxyl compound, a silane, a lithium salt, for example, lithium bis(trifluoromethanesulfonyl)imide (LiTFSI), lithium hexafluorophosphate (LiPF₆), lithium bis(oxalato)borate (LiBOB), lithium difluoro(oxalato)borate (LiDFOB) or lithium nitrate (LiNO₃), a nitrate, sultones, a sulfone, a phosphate or a phosphoric acid ester, an ionic fluid, an organic sulfite or a polymerizable monomer or oligomer.

An additive in the form of a nitrate may be used with lithium-sulfur secondary battery cells, for example. In this case, the nitrate is able to suppress the so-called shuttle mechanism and thereby increase the efficiency of the secondary battery cell. An additive in the form of a lithium salt containing boron may be used, for example, on the cathode side of lithium-based high-voltage battery cells. The lithium salt containing boron decomposes at higher electrical voltages and forms a protective layer on the cathode, thereby suppressing further oxidative decomposition of the electrolyte.

According to one advantageous embodiment, a diffusion-induced mass flow of the additive increases with an increase in the ambient pressure. The additive may be released in a targeted manner due to an external stimulus in this way. The additive may be made available when in fact needed in this way.

According to another advantageous embodiment, a diffusion-induced mass flow of the additive increases with an increase in the ambient temperature. The additive may be made available in a targeted manner due to an external stimulus in this way. The additive may be made available when in fact needed in this way.

In another advantageous specific embodiment, it is provided that a diffusion-induced mass flow of the additive increases with an increase in electrical voltage in the environment around the capsule. For example, the capsule may decompose at least partially beyond a certain electrical limiting voltage.

Another advantageous embodiment provides that a diffusion-induced mass flow of the additive depends on the chemical composition of the environment around the capsule. For example, the capsule may decompose at least in part beyond a certain chemical composition of the environment.

The capsule is advantageously designed in such a way that it melts when the ambient temperature reaches a predefinable melting point. This may be advantageous, for example, when a critical high temperature, caused by chemical reactions, occurs in a secondary battery cell, and these chemical reactions should be suppressed as quickly as possible by the release of the total amount of additive contained in the capsule.

According to another advantageous specific embodiment, it is provided that at least one internal capsule is situated in the capsule, the interspace present between the two capsules being filled at least partially with the additive dissolved in the fluid, with the liquid additive or with the additive in the form of a solid, and the internal capsule being filled at least partially with at least one additive dissolved in a fluid, a liquid additive or an additive in the form of a solid. An additive which diffuses continuously into the electrolyte may be present in the interspace between the external capsule and the internal capsule. The internal capsule may melt at approximately 120° C., for example, and may thereby release additives in the form of reaction inhibitors in order to prevent further heating of a suitably designed secondary battery cell due to chemical reactions. In this process, the external capsule preferably melts at a temperature lower than the melting point of the internal capsule. Three or more capsules may also be nested one inside the other. Furthermore, the internal capsule may be designed in coordination with the additional additive, in such a way that the additional additive may reach the environment around the internal capsule by diffusion out of the internal capsule.

An additional advantageous embodiment provides that the additive is designed for forming a protective layer on an electrode of the secondary battery cell. For example, the additive may diffuse continuously into the electrolyte and thereby continuously stabilize, for example, an SEI protective layer provided on a metal electrode, a graphite electrode or a metal alloy electrode. Alternatively, the additive may have a flame-retardant effect. Alternatively, the additive may effectuate an overload protection, an increase in conductivity, an increase in oxygen solubility, suppression of aluminum corrosion or the like. Alternatively, the additive may be embodied as an HF scavenger, an Mn scavenger or the like.

It is additionally considered to be advantageous if the additional additive has at least one reaction inhibitor. The reaction inhibitor preferably suppresses chemical reactions within the electrolyte, which would have harmful effects on a secondary battery cell designed accordingly.

The internal capsule is preferably designed in such a way that it melts when the ambient temperature reaches a predefinable melting point. This may be advantageous, for example, when a critical high temperature occurs in a secondary battery cell due to chemical reactions, which should be suppressed as quickly as possible by releasing the total additive content in the internal capsule. The external capsule should melt at a temperature below the melting point of the internal capsule.

According to one advantageous embodiment, the capsule and/or the internal capsule is/are made of at least one polymer. The capsule may be formed by one or multiple layers. In addition, the capsule may contain carbons, ceramic particles or the like. The polymers used may include, for example, polyacrylates, polystyrenes, polyethylene, polyurethanes, polyepoxies, polyesters, polypropylene, polyvinylidene fluoride (PVDF), styrene-butadiene rubbers (SBR), various copolymers or the like. Alternatively, the capsules may also be formed by polymerization of a monomer or oligomer, which is suitable in particular for forming one of the polymers mentioned above. Combinations of the materials mentioned above are also possible.

In addition, the subject matter of the present invention is an electrolyte for a secondary battery cell, which is characterized by at least one additive according to one of the aforementioned embodiments or an arbitrary combination of same. The advantages mentioned above with respect to the additive are associated with this electrolyte accordingly.

Different separate capsules, which melt at different temperatures and contain different additives, may be present in the electrolyte. For example, a capsule which melts at approximately 60° C. may contain a different additive than a capsule which melts at approximately 120° C. The capsules which melt at approximately 60° C. may contain, for example, an additive which stabilizes the anode and/or the cathode of a suitably designed secondary battery cell. The capsules which melt at approximately 120° C. may contain monomers which act as reaction inhibitors.

The subject matter of the present invention is also a secondary battery cell, which has electrodes, at least one separator and one electrolyte and is characterized by an additive according to one of the aforementioned embodiments or an arbitrary combination of same. The advantages mentioned above with reference to the additive are associated with this secondary battery cell accordingly.

According to one advantageous embodiment, the at least one additive unit of the additive is situated in an electrode or on the separator. The additive may be situated in the positive electrode (cathode) in particular. The capsule may also assume a structure-supporting function on an electrode. It is also possible to provide that the capsule is designed in such a way that it dissolves in the electrolyte over time. The porosity of the cathode of a secondary cell battery having a corresponding design is increased by the dissolution of capsules situated in an electrode, which in the case of lithium-sulfur secondary battery cells may result in a better utilization of sulfur and a better current rating, for example.

The secondary battery cell may be designed, for example, as a lithium ion secondary battery cell, a lithium-metal secondary battery cell (lithium-sulfur cells, lithium-air cells) or as a lithium-based high-voltage secondary battery cell (overlithiated cobalt oxides, nickel oxides or manganese oxides). Such cells may be used, for example, in applications such as tools, mobile devices, computers, hybrid vehicles and plug-in hybrid vehicles as well as purely electrically driven motor vehicles.

The subject matter of the present invention is also a method for manufacturing an additive according to one of the aforementioned embodiments or an arbitrary combination of same, the at least one additive unit being manufactured by spray drying or a polymerization process. For example, emulsion polymerization, suspension polymerization or dispersion polymerization may be used as the polymerization process. Furthermore, different types of polymerization may be used, such as radical, anionic or cationic polymerization, polyaddition, polycondensation or the like, for example.

### BRIEF DESCRIPTION OF THE DRAWINGS

FIG. 1 shows a schematic diagram of a cross section through an exemplary embodiment of an additive unit for an additive according to the present invention.

FIG. 2 shows a schematic diagram of a cross section through another exemplary embodiment of an additive unit for an additive according to the present invention.

### DETAILED DESCRIPTION

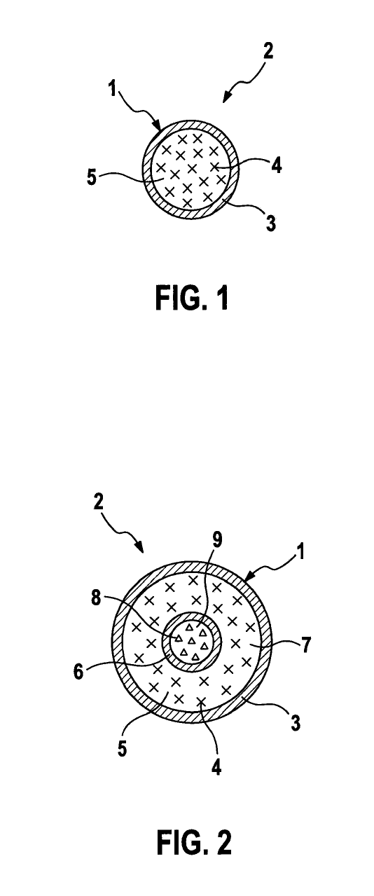

FIG. 1 shows a schematic diagram of one exemplary embodiment of an additive unit 1 for an additive 2 according to the present invention for an electrolyte (not shown) of a lithium-based secondary battery cell (not shown). Additive unit 1 includes a closed capsule 3 which is filled with a fluid 5 containing at least one additive 4. As an alternative, instead of being filled with fluid 5 containing additive 4, capsule 3 may also be filled with a liquid additive 4 or with an additive 4 in the form of a solid. Capsule 3 is designed in coordination with additive 4, in such a way that additive 4 may be released into the environment around capsule 3 by diffusion out of capsule 3 and thus into an electrolyte around capsule 3.

FIG. 2 shows a schematic diagram of a cross section through another exemplary embodiment of an additive unit 1 for an additive 2 according to the present invention. In contrast with the exemplary embodiment shown in FIG. 1, an internal capsule 6 is situated in capsule 3, interspace 7 present between two capsules 3 and 6 being filled with fluid 5 containing at least one additive 4, and internal capsule 6 being filled with a fluid 9 containing at least one additional additive 8.

What is claimed is:

1. An additive for an electrolyte of a lithium-based secondary battery cell, comprising:
at least one additive unit that includes a closed capsule filled at least partially one of with at least one additive dissolved in a fluid and with at least one liquid additive, wherein the capsule is designed in coordination with the additive in such a way that the additive may reach an environment around the capsule by diffusion out of the capsule.

2. An additive for an electrolyte of a lithium-based secondary battery cell, comprising:
at least one additive unit that includes a closed capsule filled at least partially with at least one additive in the form of a solid, wherein the additive liquefies above a predefinable temperature limiting value, the capsule being designed in coordination with the additive, in such a way that the liquefied additive may reach an environment around the capsule by diffusion out of the capsule.

3. The additive as recited in claim 1, wherein a diffusion-induced mass flow of the additive increases with an increase in an ambient pressure.

4. The additive as recited in claim 1, wherein a diffusion-induced mass flow of the additive increases with an increase in an ambient temperature.

5. The additive as recited in claim 1, wherein a diffusion-induced mass flow of the additive increases with an increase in an electrical voltage in the environment around the capsule.

6. The additive as recited in claim 1, wherein a diffusion-induced mass flow of the additive depends on a chemical composition of the environment around the capsule.

7. The additive as recited in claim 1, wherein the capsule is designed in such a way that the capsule melts when the ambient temperature reaches a predefinable melting point.

8. The additive as recited in claim 1, further comprising:
an internal capsule situated in the closed capsule, wherein:
an interspace present between the internal capsule and the closed capsule is at least partially filled one of with the additive dissolved in the fluid, with a liquid additive, and with an additive in the form of a solid, and
the internal capsule is filled at least partially one of with at least one second additive dissolved in a fluid, with a second liquid additive, and with a second additive in the form of a solid.

9. The additive as recited in claim 1, wherein the additive forms a protective layer on an electrode of the secondary battery cell.

10. The additive as recited in claim 9, wherein the at least one second additive dissolved in the fluid has at least one reaction inhibitor.

11. The additive as recited in claim 8, wherein the internal melts when an ambient temperature reaches a predefinable melting point.

12. The additive as recited in claim 1, wherein at least one of the closed capsule and the internal capsule is made of a polymer.

13. An electrolyte for a secondary battery cell, comprising:
at least one additive for an electrolyte of a lithium-based secondary battery cell, the additive including:
at least one additive unit that includes a closed capsule filled at least partially one of with at least one additive dissolved in a fluid and with at least one liquid additive, wherein the capsule is designed in coordination with the additive in such a way that the additive may reach an environment around the capsule by diffusion out of the capsule.

14. A secondary battery cell, comprising:
electrodes;
at least one separator;
at least one electrolyte; and
at least one additive for an electrolyte of a lithium-based secondary battery cell, the additive including:
at least one additive unit that includes a closed capsule filled at least partially one of with at least one additive dissolved in a fluid and with at least one liquid additive, wherein the capsule is designed in coordination with the additive in such a way that the additive may reach an environment around the capsule by diffusion out of the capsule.

15. The secondary battery cell as recited in claim 14, wherein the at least one additive unit is situated one of in one of the electrodes and on the separator.

16. A method for manufacturing at least one additive for an electrolyte of a lithium-based secondary battery cell, the additive including at least one additive unit that includes a closed capsule filled at least partially one of with at least one additive dissolved in a fluid and with at least one liquid additive, wherein the capsule is designed in coordination with the additive in such a way that the additive may reach an environment around the capsule by diffusion out of the capsule, the method comprising:
manufacturing the at least one additive unit one of by spray drying and by a polymerization process.
